(19) United States
(12) Patent Application Publication
(10) Pub. No.: US 2016/0068207 A1
(43) Pub. Date: Mar. 10, 2016

(54) DEVICE FOR HOLDING A MOTOR VEHICLE DOOR IN AN AJAR POSITION

(71) Applicant: EXSTO THERMOPLASTICS, Roman sur Isere (FR)

(72) Inventors: Eloi MOYART, Loriol (FR); Olivier BOURGEOIS, Le Pin (FR); Sébastien PRETOT, Saint Hilaire du Rosier (FR)

(21) Appl. No.: 14/785,210

(22) PCT Filed: Apr. 16, 2014
(86) PCT No.: PCT/FR2014/050925

§ 371 Date: Oct. 16, 2015

(30) Foreign Application Priority Data
Apr. 16, 2013 (FR) 13/53431
Jun. 11, 2013 (FR) 13/55362

(51) Int. Cl. B62D 65/02; E05C 21/00; B05B 13/02

(52) U.S. Cl. CPC B62D 65/026; B05B 13/0292; E05C 21/005

(57) ABSTRACT

A device for holding a motor vehicle door in an ajar position during the manufacture of the vehicle, including: a body; fastening means designed to fasten the body to the door, preferably to a fastening area intended to accommodate a lock; a retaining member mounted on the body and arranged to bear on a first side of the car body member and hold the door in an ajar position; and a stop member mounted on the body and arranged to extend away from the door in such a way as to define a space between the stop member and the door, the stop member being arranged to bear on a second side of the car body member and prevent the door from closing.

The present invention relates to a device for holding a motor vehicle door in an ajar position during the manufacture of this motor vehicle.

Particularly, but not exclusively, the device according to the invention applies during a treatment operation of the body of type painting or anti-corrosion.

It is known to use devices for holding the opening elements, such as doors, hood, or the trunk of a motor vehicle in an ajar position during the manufacture of this motor vehicle.

Thus, the manufacturers rid themselves of any issue of touching the opening elements against the body elements and prevent the untimely opening of the opening elements during manufacture.

More particularly, document WO2006/018193 discloses a device including:
a body;
fastening tabs mounted on the body and designed to be passed through a lumen arranged in an upper post and substantially horizontal with a door;
an arm mounted on the body and arched for bearing on a first side of the roof element and holding the door in an ajar position; and
a lip mounted on the body and arranged for bearing on a second side of the roof element and preventing the closing of the door.

One drawback of this device resides in the fact that, during a painting operation, the paint gathers on the edge of the door and the device. Thus, the paint forms drops which stream from the device onto a door area visible by the user once the door is equipped. Thus, defacing the aesthetic of the vehicle.

Furthermore, the arm ensuring the hold of the door in an ajar position is liable to rub against the roof element. Plastic or metal grains generated by this rubbing may be deposited on areas of the door or the body visible by the user once the vehicle is equipped. Thus, the aesthetic of the vehicle is even more damaged.

The invention aims to remedy to all or part of these drawbacks.

The invention relates to a device for holding a motor vehicle door in an ajar position with respect to a body element during the manufacture of this motor vehicle, characterized in that it includes:
a body;
fastening means designed for fastening the body on the door on a fastening area disposed inside the vehicle;
a retaining member mounted on the body and arranged for bearing on a first side of the body element and retaining the door in an ajar position; and
a stop member mounted on the body and arranged to be extended at a distance from the door in such a manner as to delimit a space between the stop member and the door, the stop member being arranged for bearing on a second side of the body element and preventing the closing of the door.

As defined by the present description, an area of a door is said to be “disposed inside” the vehicle if the latter is protected from the fluids, such as bad weather, sealing members, when the door is in closed position.

An area is said to be “disposed on the outside” of the vehicle if the latter is not protected from the fluids, such as bad weather, by sealing members, when the door is in closed position.

The term “mounted” is meant in its broadest sense, that is to say, mounted directly or indirectly, in a removable or non removable manner.

The retaining member is opposed to the displacement of the door towards the open position whereas the stop member is opposed to the displacement of the door towards closed position. Thus, the door may be held in an ajar position during a treatment operation.

As opposed to the device disclosed in document WO2006/018193, the stop member of the device according to the invention is distinct from the fastening means extends at a distance from the door. Thus, the stop member does not bear on a door edge. The space arranged between the stop member and the door allows treating the door behind the stop member. Furthermore, the risk of runs by accumulation of paint on the stop member is reduced.

The fastening area of the door is disposed inside the vehicle. Thus, even if the fastening area is not treated during the treatment operation, this fastening area is not or hardly subjected to corrosion.

When the fastening area of the door is further disposed laterally and centered, the fastening area is disposed laterally thereby limiting the risk of torsioning of the door and reducing the risk of unwanted touching at the top or at the bottom of the door.

Furthermore, the body element facing the fastening area, namely a vertical window post, is usually not aggressive. Thus, the quantity of grains liable to be produced by rubbing of the retaining member against the body element is minimized.

The device according to the invention may include one or several of the following features.

According to one feature, the stop member takes the form of an arched arm.

According to another feature, the stop member is arranged for bearing on a groove of the body element intended to receive a sealing member.

As a result, if during the treatment operation the stop member bears on the groove of the body element, the part of the groove which is not treated is protected from corrosion by the sealing member.

Preferably, the fastening means comprise at least one first locking member mounted on the body, the first locking member having a locking portion and being displaceable between:
an unlocked position in which the locking portion is liable to have passed through a lumen arranged in the door; and
a locked position in which the locking portion is liable to bear on the door in order to ensure the fastening of the body to the door.

According to a feature, the locking portion of the first locking member has a sliding face forming a ramp against which an edge of the lumen arranged in the door is liable to slide, so as to allow the locking portion to pass through this lumen; and
the locking portion of the first locking member has a stop face liable to bear on the door after having passed through said lumen, so as to ensure the fastening of the body to the door.

In one embodiment, the first locking member has an actuating portion designed to be actuated by a user so as to displace the first locking member between the unlocked position and the locked position.

Preferably, the first locking member is pivotally mounted around an axis arranged to extend parallel to the lumen arranged in the door; and

the locking portion and the actuating portion of the first locking member extend on either side of the axis.

According to a possibility, the first locking member is mounted removeably on the body.

According to another possibility, the first locking member is mounted unremoveably on the body, and is connected to the body by an elastically deformable connecting member.

Preferably, the device includes a bolting member designed to bolt the first locking member in locked position.

Preferably, the bolting member has a sliding face forming a ramp against which the actuating portion of the first locking member is liable to slide during a displacement of its unlocked position to its locked position; and

the bolting member has a stop face against which the actuating portion of the first locking member is liable to bear on in locked position.

In one embodiment, the device includes a second locking member mounted removeably on the body;

the second locking member has a locking portion and an actuating portion designed to be actuated by a user so as to displace the second locking member between:
an unlocked position in which the locking portion of the second locking member is liable to have passed through the lumen arranged in the door; and
a locked position in which the locking portion of the second locking member is liable to bear on the door so as to ensure that the body is fastened to the door:

the first locking member and the second locking member are connected by an elastically deformable connecting portion so as to form pliers.

According to a feature, the first locking member is provided with a bolting member;

the second locking member is provided with an opening arranged so as to cooperate with the bolting member;

the bolting member has a sliding face forming a ramp against which an edge of the opening arranged in the second locking member is liable to slide, so as to allow the bolting member to pass through this opening; and

the bolting member has a stop face liable to bear on the second locking member after the bolting member has passed through said opening, to ensure the bolting of the first locking member and the second locking member in locked position.

In one embodiment, the first locking member has a connecting portion connected to the body and liable to be elastically deformed for displacing the first locking member between the unlocked position and the locked position.

In a variant of this embodiment, the fastening means comprise a second locking member extending substantially parallel to the first locking member.

In another embodiment, the fastening means comprise a plate mounted on the body and provided with a lumen, this lumen having a section that is substantially identical to the section of a lumen arranged in the door; and

the first locking member is removeably mounted on the body and has an actuating portion designed to be actuated by a user so as to displace the first locking member between:
an unlocked position in which the locking portion of the first locking member is liable to be engaged through the lumen arranged in the plate and the lumen arranged in the door; and
a locked position in which the locking portion of the first locking member pivots around an axis, preferably by a quarter of a revolution, so as to bear on the door and fasten the body to the door.

According to a feature, the axis is arranged to extend transversally to the lumen arranged in the door and to the lumen arranged in the plate.

In one embodiment, the door is provided with at least one lumen;

the fastening means comprise a plate mounted on the body, provided with at least one protuberance of general “L” shape, this protuberance being arranged to be transversally engaged in a lumen of the door then translated substantially parallel to the lumen of the door, so as to bear on the door; and

the fastening means comprise a locking member mounted on the plate, the locking member having a locking portion, an actuating portion and a connecting portion connecting the locking portion and the actuating portion, the locking member being elastically deformable between:
an unlocked position in which the locking portion allows the engaging of said protuberance in said lumen of the door; and
a locked position in which the locking portion prevents the clearing of said protuberance in said lumen of the door.

In another embodiment, the fastening means comprise a plate mounted on the body and provided with an orifice; and

the fastening means comprise a screw liable to be engaged through the orifice arranged in the plate and the orifice arranged in the door and bolted so as to ensure that the body is fastened to the door.

According to a feature, the fastening means comprise a finger designed to be engaged through an orifice arranged in the door.

According to another feature, the device includes stabilizing members disposed on either side of the fastening means, each stabilizing means being provided with a plate arranged to bear on the door.

According to yet another feature, the retaining member may be produced, at least in part, from a polymer of which the hardness ranges between 90 Shore A scale and 60 Shore D scale and of which the resistance to tear measured according to ISO 34-1 is higher than 70 kN/m.

According to a feature, the device is associated with a protecting member (or otherwise called an interface), for example of general “U” shape, provided to be mounted on a sharp part of the body element, more precisely on a sharp rim of the body element, and more preferentially on the aforementioned groove of the body element, and against which the stop member bears.

In one embodiment of the invention, the protective member comprises a profiled element including a base, a first lateral wall and a second lateral wall which together delimit a housing intended to receive a sharp part of the body element, preferably the groove of the body element, said first lateral wall and/or said second lateral wall having a radial elasticity determined such that the first lateral wall and/or the second lateral wall are spaced apart from each other so as to put the sharp part of the body element, preferably the groove of the body element, in said housing then they become closer to each other so as to ensure holding the sharp part of the body element, preferably the groove of the body element, in said housing of the profiled element.

In other words, the interface covers the sharp part of the body element, preferably the groove of the body element, and thus prevents the stop member of the device according to the invention from being in contact with this sharp part of the body element, preferably the groove of the body element.

The radial elasticity of the lateral walls of the profiled element thereby allows fastening the interface on the sharp part of the body element, preferably the groove of the body element. This fastening is easy to implement. The interface (or in other words called the protective member) is a compact piece, of simple design and hence cheap. In addition, the mounting and dismantling of this interface (or in other words called the protective element) are easy to carry out because of the radial elasticity of the first and second lateral walls of the profiled element.

In addition, the interface (or in other words the protective member) perfectly allows avoiding the aforementioned grain issues.

Furthermore, this interface (or in other words called the protective member) may be used when the body element on which it is fastened does not include any reinforcements and that it is provided after the painting operations to have a piece in the area where this interface was fastened (in other words that it is provided to dress the area where the interface was during the painting operations) in such a manner as not to detect the absence of paint in this area where the interface was located (or in other words called the protective member).

This interface (or in other words the protective member) may also be used if the body element on which it is fastened during the painting operations comprises a reinforcement (generally not visible by the end client), and whether it be provided or not to subsequently dress said area where the interface was during the painting operations. In fact, the interface (or in other words the protective member) is thus fastened entirely on the reinforcement during the painting operations and does not surpass the latter so as not to leave an area with no paint visible by the end client once the painting operations finished.

In a preferred manner, the profiled element has a transversal U section.

According to one embodiment of the interface (or in other words the protective member), one of the lateral walls of the profiled element further comprises at least one gripping means. The advantage of this is to be able to place the interface easily and especially to recover it easily once the painting operations over.

In an advantageous manner, one of the lateral walls of the profiled element further comprises at least one protruding element oriented on the side of the housing of the profiled element. This protruding element is configured to be pushed down or clipped in an orifice which is provided in the sharp part of the body element, preferably the groove of the body element. This protruding element constitutes another means for fastening the interface (or in other words the protective member) on the body element.

The invention also relates to a kit which comprises:
at least one device for holding a motor vehicle door in an ajar position with respect to a body element such as described above.
at least one protective member (or in other words an interface) such as described above.

In a preferred manner, the protective member (or in other words the interface) comprises a profiled element including a base, a first lateral wall and a second lateral wall which together delimit a housing intended to receive a groove of a body element, said first lateral wall and/or said second lateral wall having a radial elasticity determined in such a manner that the first lateral wall and/or the second lateral wall are spaced apart from each other to dispose the groove of the body element in said housing then become closer to each other so as to ensure holding the groove of the body element in said housing of the profiled element.

One of the lateral walls of the profiled element may further comprise at least one protruding element oriented on the side of the housing of the profiled element.

The invention also relates to a motor vehicle including at least one door and a body element, characterized in that it is equipped with a device such as introduced hereabove.

And in a preferred manner, the motor vehicle further comprises at least one protective member (or in other words an interface) such as described above.

The invention will be well understood by means of the following description, with reference to the accompanying schematic drawing representing, by way of example, ten devices for holding a motor vehicle door in an ajar position during a treatment operation according to the invention.

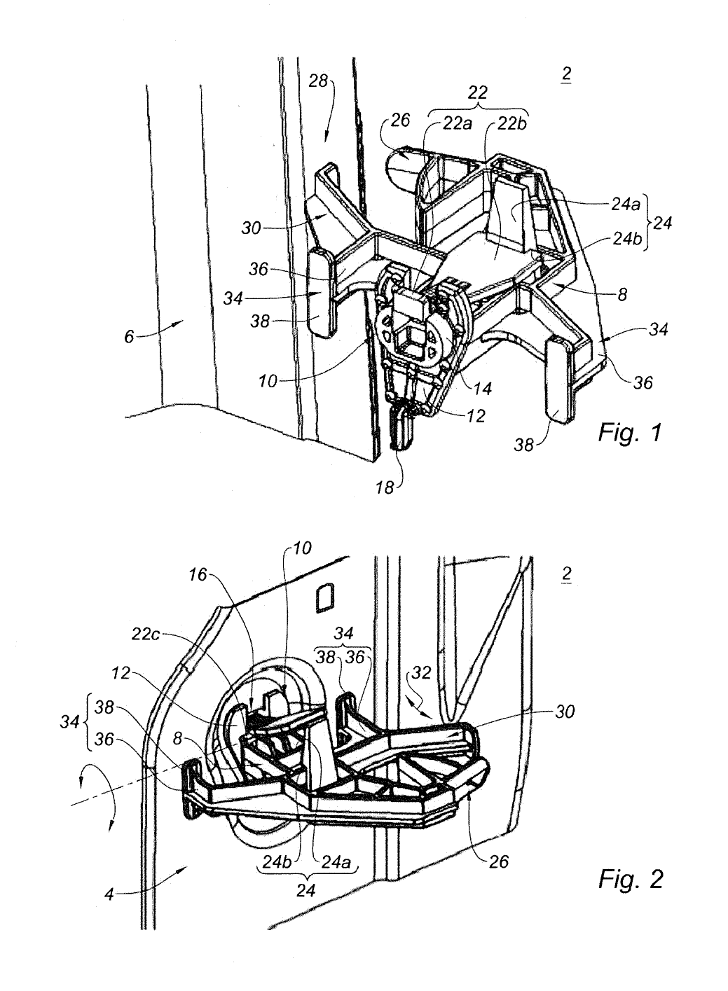

FIG. 1 is a perspective representation of a first device seen from behind;

FIG. 2 is perspective representation of the device of FIG. 1 seen from the front and fastened to a door;

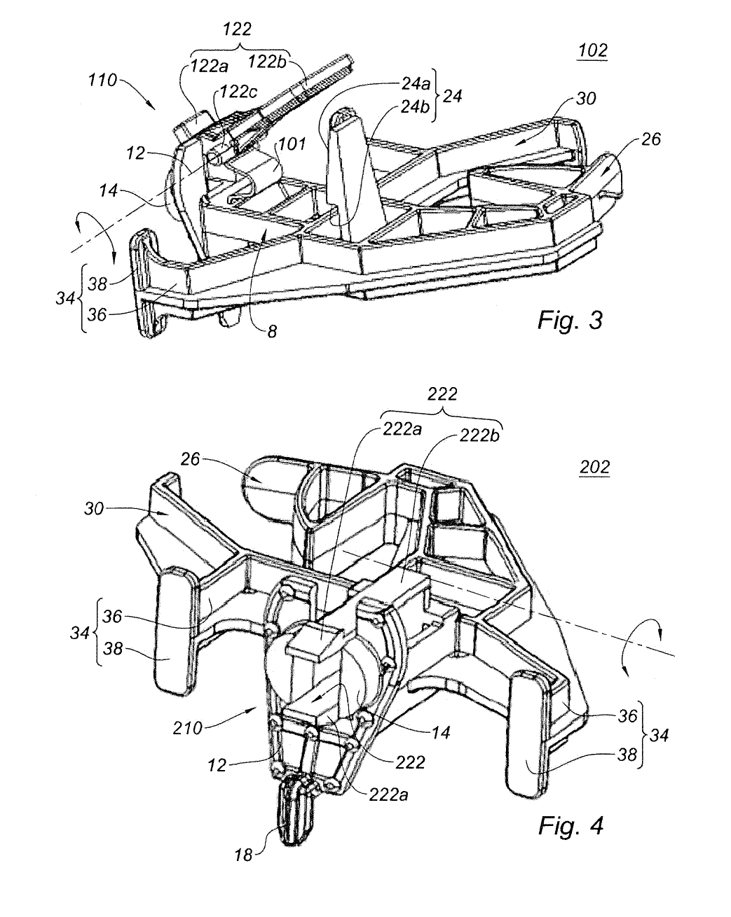

FIG. 3 is a perspective representation of a second device seen from the front;

FIG. 4 is a perspective representation of a third device seen from behind;

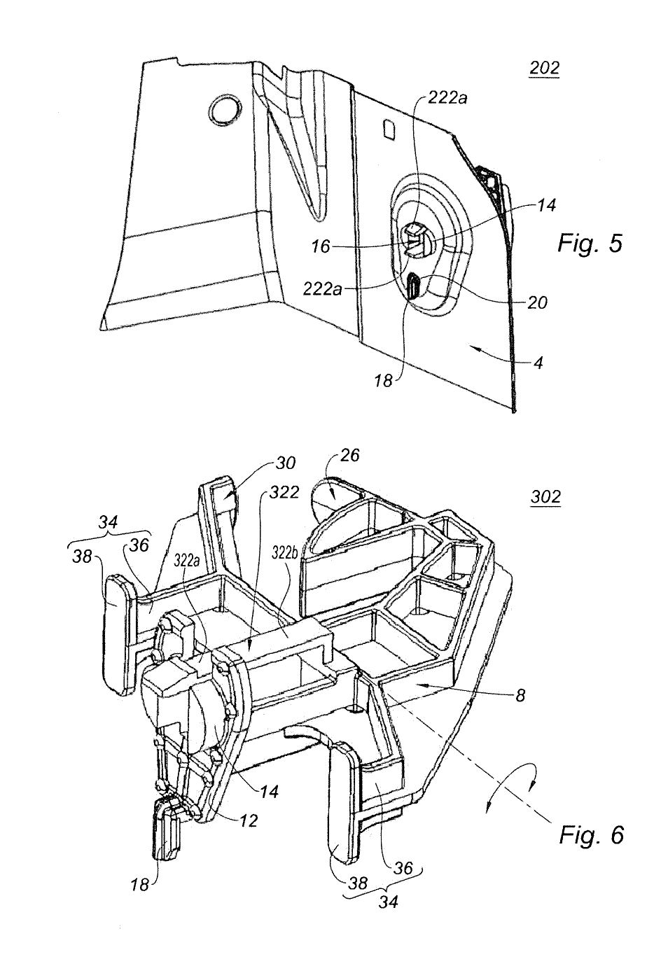

FIG. 5 is a perspective representation of the device of FIG. 4 seen from behind and fastened on a door;

FIG. 6 is a perspective representation of a fourth device seen from behind;

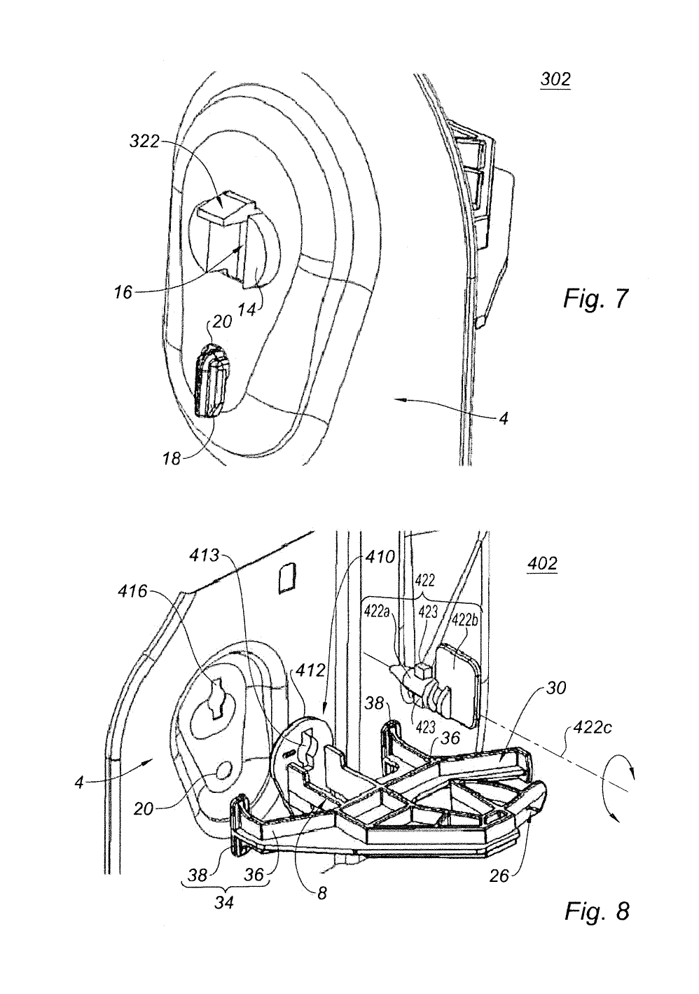

FIG. 7 is a perspective representation of the device of FIG. 6 seen from behind and fastened on a door;

FIG. 8 is a perspective representation of a fifth device seen from the front and ready to be fastened on a door;

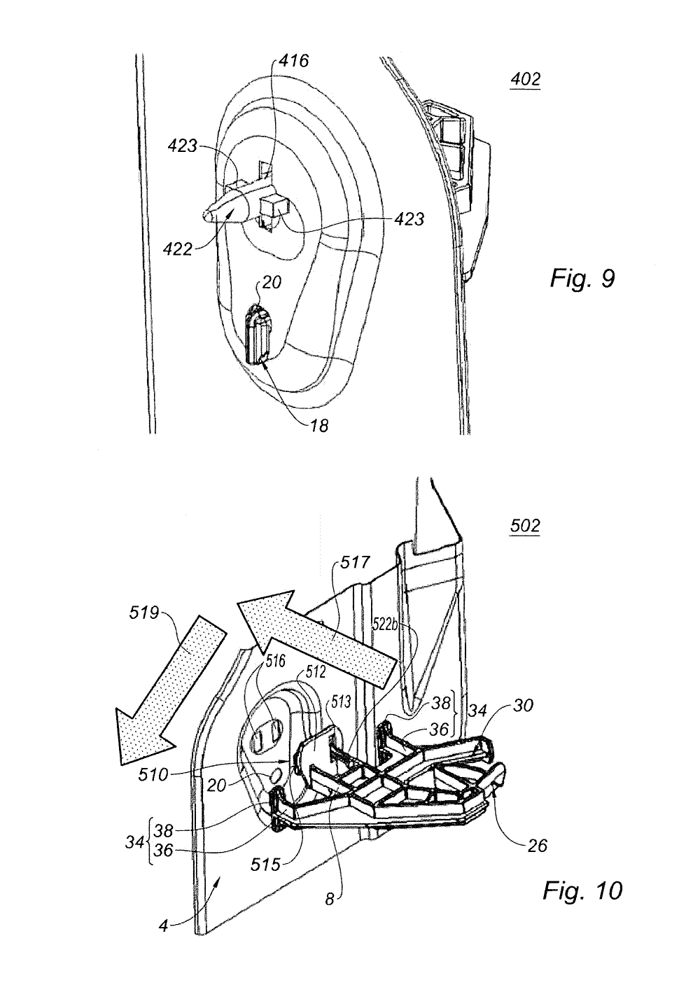

FIG. 9 is a perspective representation of the device of FIG. 8 seen from behind and fastened on the door;

FIG. 10 is a perspective representation of a sixth device seen from the front and ready to be fastened on a door;

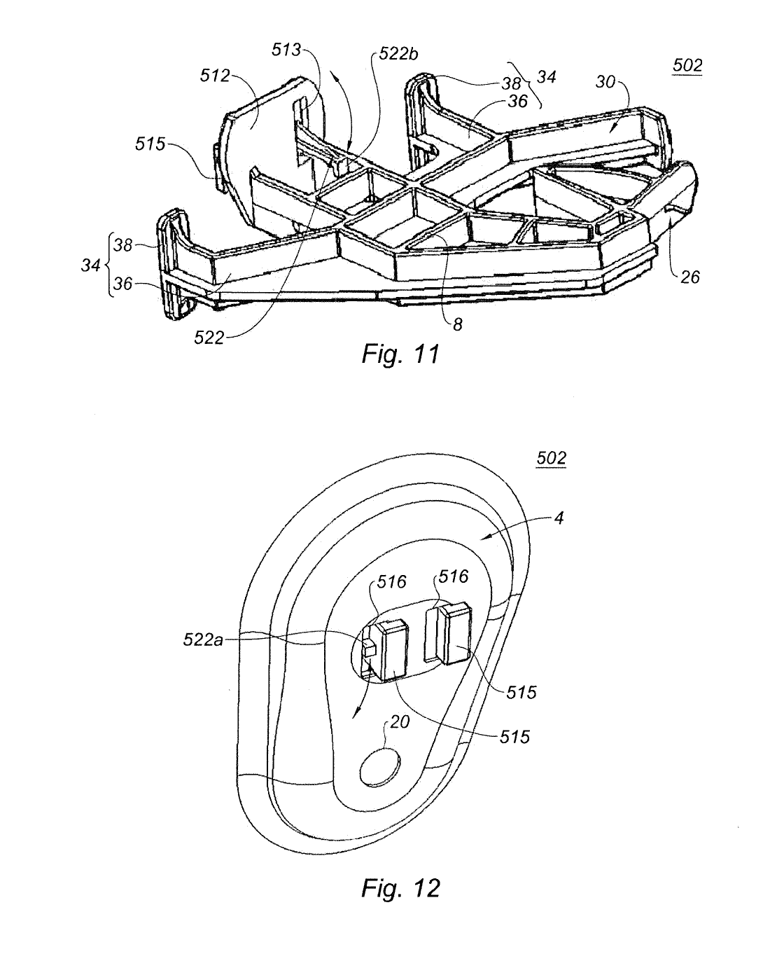

FIG. 11 is a perspective representation of the device of FIG. 10 seen from the front;

FIG. 12 is a perspective representation of the device of FIG. 11 seen from behind and fastened on the door;

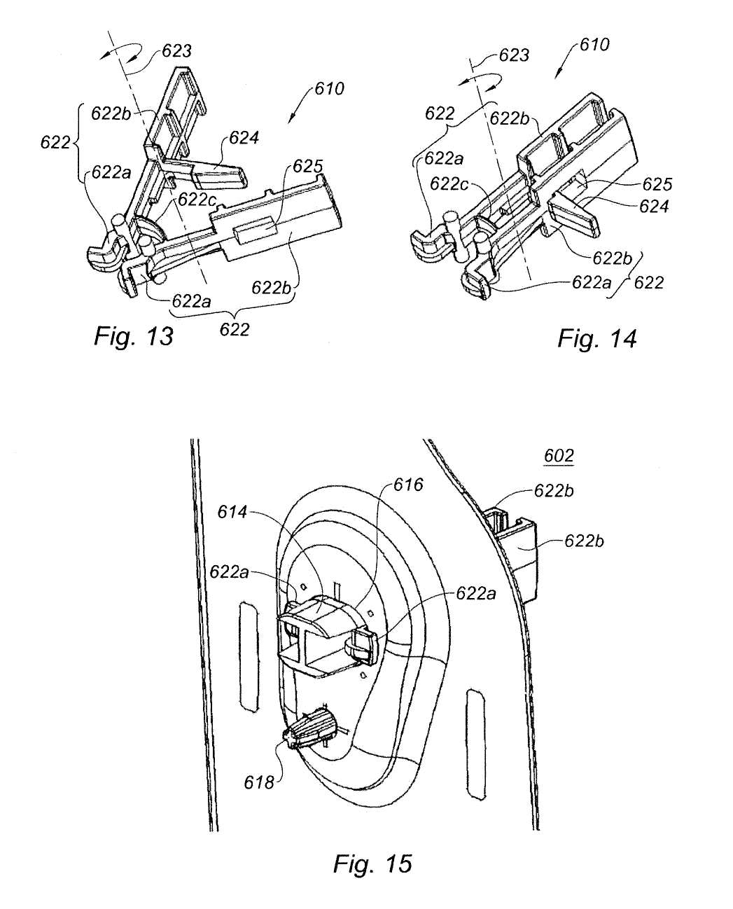

FIG. 13 is a perspective representation of a locking member in unlocked position;

FIG. 14 is a perspective representation of the locking member of FIG. 13 in locked position;

FIG. 15 is a perspective representation of a seventh device equipped with the locking member of FIGS. 13 and 14 seen from behind and fastened on a door;

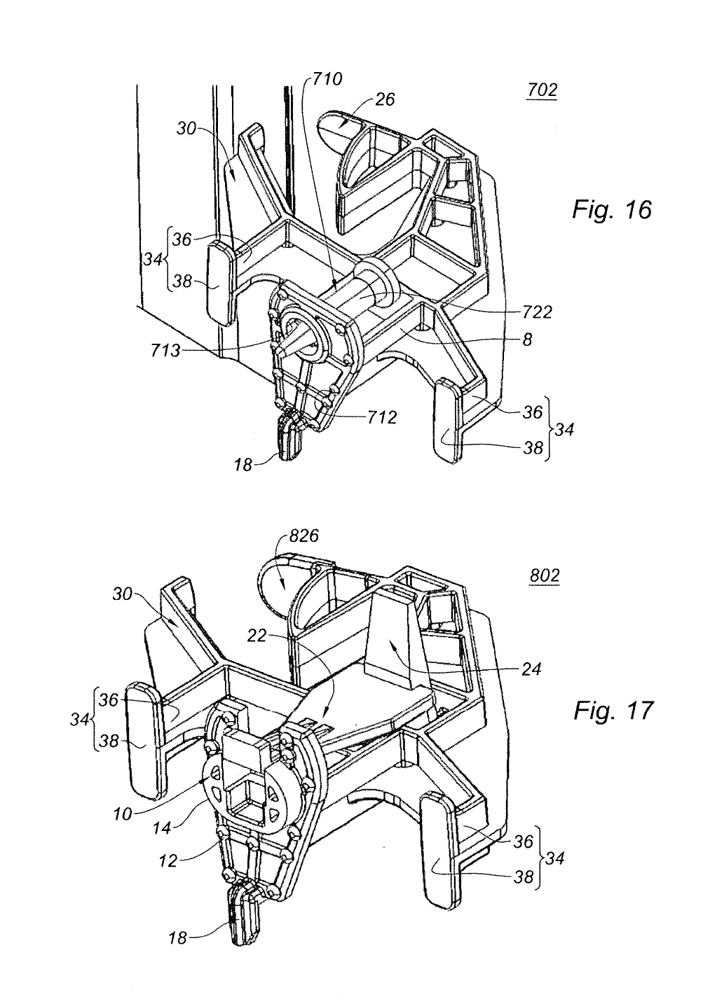

FIG. 16 is a perspective representation of an eighth device seen from behind;

FIG. 17 is a perspective representation of a ninth device seen from behind; and

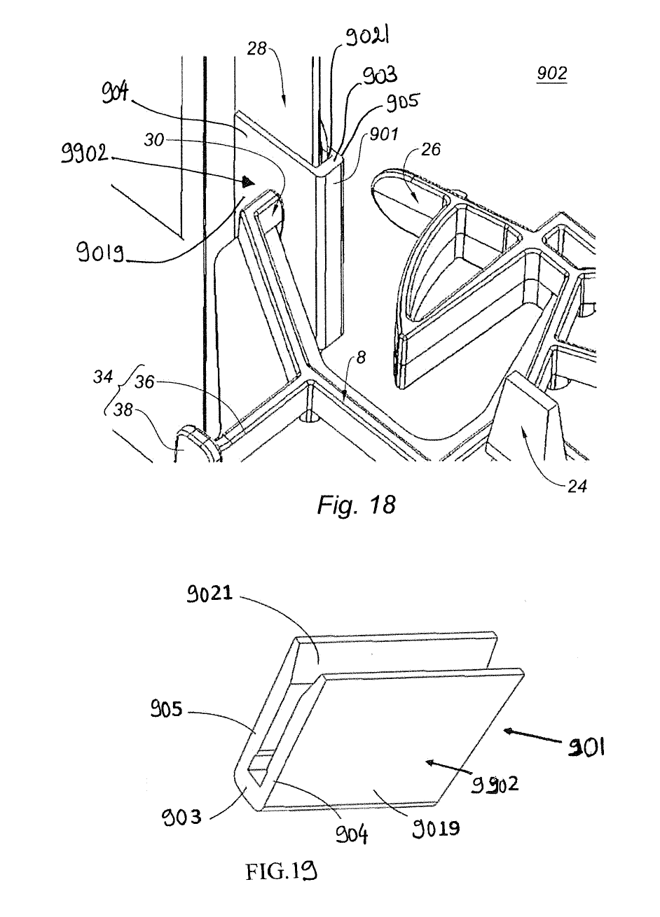

FIG. 18 is a perspective representation of a tenth device seen from behind.

FIG. 19 is a perspective view of a protective member (or in other words an interface) according to a first embodiment.

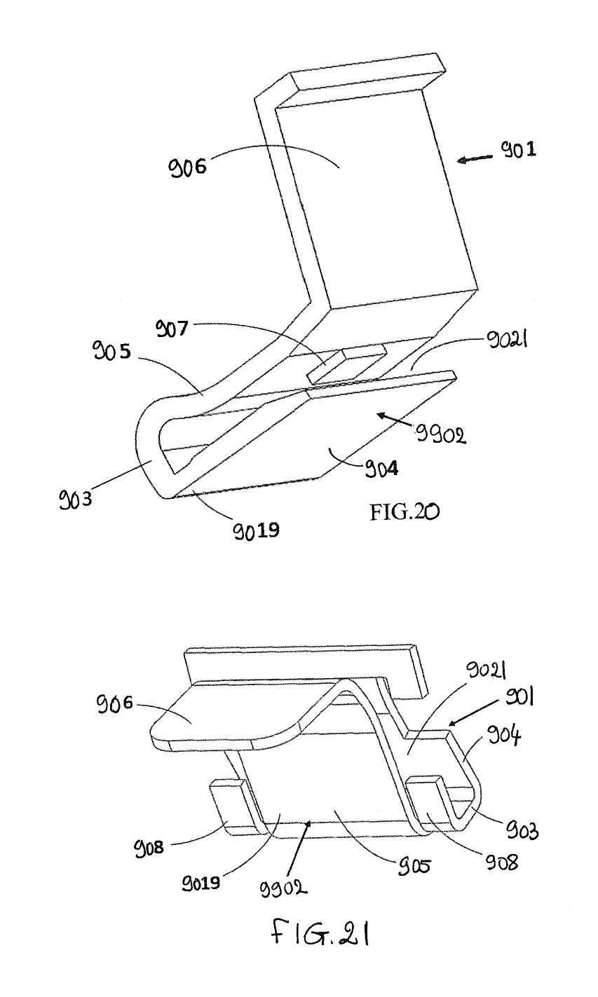

FIG. 20 is a perspective view of a protective member (or in other words an interface) according to a second embodiment.

FIG. 21 is a perspective view of a protective member (or in other words an interface) according to a third embodiment.

FIGS. 1 and 2 represent a device 2 for maintaining a door 4 of a motor vehicle in an ajar position with respect to a body element 6 during a treatment operation. The body element 6 is a vertical window post.

The device 2 includes a body 8 and fastening means 10 designed for fastening the body 8 on an area for fastening the door 4.

The fastening means 10 comprise a plate 12. This plate 12 is equipped with a protuberance 14 provided to be engaged through a lumen 16 arranged in the door 4. The plate 12 is further equipped with a finger 18 provided to be engaged in an orifice 10 arranged in the door 4.

The fastening means 10 comprise a locking member 22 removeably mounted on the body 8. The locking member 22 has a locking portion 22a and an actuating portion 22b disposed on either side of an axis 22c. The locking portion 22a extends substantially perpendicular to the actuating portion 22c. The axis 22c extends parallel to the lumen 16 arranged in the door 4. The actuating portion 22b is designed to be actuated by a user in such a manner as to pivot the locking member 22 between;
an unlocked position (represented on FIG. 2) in which the locking portion 22a is liable to be passed through the lumen 16 arranged in the door 4; and
a locked position (represented on FIG. 1) in which the locking portion 22a is liable to bear on the door 4 so as to ensure the fastening of the body 8.

The device 2 includes a bolting member 24 designed to bolt the locking member 22 in locked position.

The bolting member 24 has a sliding face 24a forming a ramp against which the actuating portion 22b of the locking member 22 is liable to slide during a displacement from its unlocked position to its locked position. The bolting member 24 further has a stop face 24b against which the actuating portion 22b of the locking member 22 is liable to bear in locked position.

The device 2 includes a retaining member 26 mounted on the body 8. The retaining member 26 takes the form of an arched arm. The retaining member 26 is arranged to bear on a first side of a groove 28 of the body element 6 and retain the door 4 in an ajar position.

The device 2 includes a stop member 30 mounted on the body 8 facing the retaining member 26. The stop member 30 takes the form of an arched arm. The stop member 30 is arranged to bear on a second side of the groove 28 of the body element 6 and prevent the door 4 from closing.

The stop member 30 extends at a distance from the door 4 (such as represented on FIG. 2) so as to delimit a space 32 between the stop member 30 and the door 4. Thus, during a treatment operation, for example a painting operation, the door 4 may be painted behind the stop member 30.

The device 2 includes stabilizing members 34 disposed on either side of the fastening means 10. Each stabilizing member 34 comprises an arm 36 bearing a plate 38. Each plate 38 is arranged to bear on the door 4.

One embodiment of the device 2 is now described. Initially, the door 4 is in an open position. The locking member 22 and the body 8 are dismantled with respect to each other.

During a first step, a user fastens the body 8 to the door 4. To this end, the user engages the finger 18 in the orifice arranged in the door 4 then the protuberance 14 in the lumen 16.

Then, the user adds the locking member 22 on the body 8 and positions the locking member 22 in unlocked position.

Finally, the user pivots the locking member 22 around the axis 22c until the bolting member 24 bolts the locking member 22 in locked position.

During a second step, the user displaces the door 4 from its open position to its ajar position. The retaining member 26 bears on the first side of the groove 28 of the body element 6, bends, becomes deformed and bears on the second side of the groove 28. The door 4 is in an ajar position.

In these conditions, the retaining member 26 prevents the displacement of the door 4 from the ajar position to the open position. The stop member prevents the displacement of the door 4 from the ajar position to the closed position. A slight course of the door remains nevertheless possible.

FIG. 3 represents a device 102 identical to the device 2 except that the fastening means 10 are replaced by fastening means 110.

The fastening means 110 differ from the fastening means 10 in that a locking member 122 is mounted unremoveably on the body 8. The locking member 122 is connected to the body 8 by an elastically deformable connecting member 101.

FIGS. 4 and 5 represent a device 202 which is identical to the device 2 except that the fastening means 10 are replaced by fastening means 210. These fastening means 210 comprises two locking members 222 extending parallel to each other.

Each locking member 222 has a locking portion 222a and a connecting portion 222b connected to the body 8. Each locking member is liable to be elastically deformed between:
an unlocked position in which the locking portion 222a is liable to be passed through the lumen 16 arranged in the door 4; and
a locked position (represented on FIG. 5) in which the locking portion 222a is liable to bear on the door 4 so as to ensure the fastening of the body 8.

Each locking portion 222a has a sliding face forming a ramp against which an edge of the lumen 16 arranged in the door is liable to slide.

Each locking portion 222a further has a stop face liable to bear on the door 4 after having passed through said lumen, so as to ensure the fastening of the body 8.

FIGS. 6 and 7 represent a device 302 which is identical to the device 202 except that the fastening means 210 are replaced by fastening means 310. These fastening means 310 comprise a single locking member 322. The locking member 322 is identical to the locking members 222.

FIGS. 8 and 9 represent a device 402 which is identical to the device 2 except that the fastening means 10 are replaced by fastening means 410.

The fastening means 410 comprise a plate 412 mounted on the body and provided with a lumen 413. The lumen 413 has a section which is substantially identical to the section of a lumen 416 arranged in the door 4.

The fastening means 410 comprise a locking member 422 mounted removeably on the body 8. The locking member 422 has a locking portion 422a provided with diametrically opposite studs 423 and an actuating portion 422b. The actuating portion 422b is designed to be actuated by a user so as to displace the locking member 422 between:
an unlocked position (represented on FIG. 8) in which the locking portion 422a of the locking member 422 is liable to be engaged through the lumen 413 arranged in the plate 412 and the lumen 416 arranged in the door 4; and
a locked position (represented on FIG. 9) in which the locking portion 422a of the locking member 422 is pivoted by a quarter of a revolution around an axis 422c so that the studs 423 of the locking portion 422a bear on the door 4 and fasten the body 8 to the door 4. The axis 422c extends transversally to the lumen 413 arranged in the plate 412 and the lumen 416 arranged in the door 4.

FIGS. 10 to 12 represent a device 502 which is identical to the device 2 except that the fastening means 10 are replaced by fastening means 510.

The fastening means 510 comprise a plate 512 mounted on the body 8. The plate 512 is provided with a lumen 513 and two protuberances 515 of a general “L” shape. Each protuberance 515 is arranged to be engaged in a lumen 516 of same section arranged in the door 4.

The fastening means 510 comprise a locking member 522 mounted on the plate 512. The locking member 522 has a locking portion 522a, an actuating portion 522b and a connecting portion (not represented) connecting the locking portion 522a and the actuating portion 522b. The connecting portion extends through the lumen 513 in the plane of the plate 512.

The locking member 522 is elastically deformable between:
an unlocked position (not represented) in which the actuating portion 522b is lifted by a user and the locking portion 522a is moved back; and
a locked position (represented on FIG. 12) in which the actuating portion 522b is released by the user and the locking portion 522a is moved forward.

In unlocked position, the protuberances 515 may be positioned in the lumens 516. The protuberances 515 are engaged in the lumens 516 along an axis 517 which is transversal to the lumens 516. Then, the protuberances 515 are translated in the lumens 516 along an axis 519 parallel to the lumens 516. The protuberances 515 bear on the door 4.

In locked position (represented on FIG. 12), the locking portion 522a is moved forward and engaged in one of the lumens 516 preventing clearing the protuberance 515 received in this lumen 516. Thus, fastening the body 8 to the door 4 is ensured.

The fastening means 510 finally differ in that the finger 18 is omitted.

FIGS. 13 to 15 represent a device 602 which is identical to the device 2 except that the fastening means 10 are replaced by fastening means 610.

The fastening means 610 comprise locking members 622 arranged like pliers. Each locking member 622 has a locking portion 622a and an actuating portion 622b. The locking members 622 are connected by an elastically deformable connecting portion 622c.

The actuating portions 622b are designed to be actuated by a user such as to pivot the locking members 622 around an axis 623 between:
an unlocked position (represented on FIG. 13) in which the locking portions 622a are liable to be passed through a lumen 616 arranged in the door 4 simultaneously with a protuberance 614, here of oblong section; and
a locked position (represented on FIGS. 14 and 15) in which the locking portions 622a bear on the door 4 so as to ensure the fastening of the body 8 One of the locking members 622 is provided with a bolting member 624 and the other of the locking members 622 is provided with an opening 625 arranged to cooperate with the bolting member 624. Thus, the locking members 622 may be bolted in locked position.

The bolting member 624 has a sliding face forming a ramp against which an edge of the opening 625 is liable to slide during the passage of the bolting member 624 through this opening 625.

The bolting member 624 has a stop face liable to bear on the locking member 622 provided with the opening 625 after the bolting member 624 has passed through this opening 625.

Finally, the fastening means 610 comprise a finger 618 of which the section forms a “+”. In a variant, the finger may have a shape of a conical frustrum in order to facilitate the insertion thereof.

FIG. 16 represents a device 702 which is identical to the device 2 except that the fastening means 10 are replaced by fastening means 710.

The fastening means 710 comprise a plate 712 mounted on the body 8 and provided with an orifice 713.

The fastening means 710 further comprise a screw 722 liable to be engaged through the orifice 713 arranged in the plate 712 and the orifice arranged in the door 4, then bolted so as to ensure that the body 8 is fastened to the door 4. The term “screw” is to be understood to have a threaded stem provided with a one-end head.

FIG. 17 represents a device 802 which is identical to the device 2 except for the fact that the retaining member 26 is replaced by a retaining member 826. The retaining member 826 is produced in part from a polymer of which the hardness ranges between 90 Shore A scale and 60 Shore D scale and of which the resistance to tear measured according to standard ISO 34-1 is higher than 70 kN/m.

The FIG. 18 represents a device 902 which is identical to the device 2 except for the fact that it is associated to a protective member 901 (or in other words an interface), in a general “U” form, mounted on the groove 28 of the body element 6 and against which the stop member 30 may bear.

FIG. 19 represents the protective member (or in other words the interface) 901 which is visible on FIG. 18. It consists of a first embodiment of the protective member 901. It comprises a body 9902 which is in the form of a profiled element 9019. The profiled element 9019 includes a base 903, a first lateral wall 904 and a second lateral wall 905. The inner surfaces of the base 903, of the first lateral wall 904 and the second lateral wall 905 delimiting a housing 9021 intended to receive the groove 28 of the body element 6, namely a sharp part of the body element 6. The profiled element 9019 has a transversal U section. The first lateral wall 904 and the second lateral wall 905 each has a radial elasticity.

As is visible on FIG. 18, the stop member 30 bears on the first lateral wall 904 of the protective member (or in other words the interface) 901. The protective member 901 is thus a protective interface.

FIG. 20 represents a protective member (or in other words an interface) 901 of which the body 9902 is also in the form of a profiled element 9019. This protective member 901 represented on FIG. 20 includes all the described features for the protective member 901 of FIG. 19 and it further comprises a gripping element 906 which helps to dismantle the protective member 901 following the painting operations of the groove 28 of the body element 6 on which it has been fastened.

The protective member 901 comprises on its second lateral wall 905 a protruding element 907 intended to be pushed down or clipped in a hole of the body element 6 which is not visible on the figures, in order to contribute to the fastening the protective member 901 on the body element 6.

The profiled element 9019 represented on FIGS. 19 and 20 is produced from a plastic material.

FIG. 21 represents another embodiment of the protective member 901 which is produced from a metallic material. The body 9902 also comes in the form of a profiled element 9019. Reinforcements 908 are joined to the profiled element 9019. This protective member 901 also includes a gripping means 906.

As it is known per se, the invention is not limited to the sole embodiments presented hereabove, but encompasses all the variants.

1. A device for holding a motor vehicle door in an ajar position with respect to a body element during the manufacture of this motor vehicle, wherein it includes:
a body;
fastening means designed for fastening the body on the door on a fastening area disposed inside the vehicle;
a retaining member mounted on the body and arranged for bearing on a first side of the body element and retaining the door in an ajar position; and
a stop member mounted on the body and arranged to be extended at a distance from the door in such a manner as to delimit a space between the stop member and the door, the stop member being arranged for bearing on a second side of the body element and preventing the closing of the door.

2. The device according to claim 1, wherein the stop member takes the form of an arched arm.

3. The device according to claim 1, wherein the stop member is arranged for bearing on a groove of the body element intended to receive a sealing member.

4. The device according to claim 1, wherein the fastening means comprise at least one first locking member mounted on the body, the first locking member having a locking portion and being displaceable between:
an unlocked position in which the locking portion is liable to be passed through a lumen arranged in the door; and
a locked position in which the locking portion is liable to bear on the door in order to ensure the fastening of the body to the door.

5. The device according to claim 4, wherein the locking portion of the first locking member has a sliding face forming a ramp against which an edge of the lumen arranged in the door is liable to slide, so as to allow the locking portion to pass through this lumen; and
in that the locking portion of the first locking member has a stop face liable to bear on the door after having passed through said lumen, so as to ensure the fastening of the body to the door.

6. The device according to claim 4, wherein the first locking member has an actuating portion designed to be actuated by a user so as to displace the first locking member between the unlocked position and the locked position, or inversely.

7. The device according to claim 6, wherein the first locking member is pivotally mounted around an axis arranged to extend parallel to the lumen arranged in the door; and
in that the locking portion and the actuating portion of the first locking member extend on either side of the axis.

8. The device according to claim 4, wherein it includes a bolting member designed to bolt the first locking member in locked position.

9. The device, according to claim 4, wherein it includes a second locking member removeably mounted on the body;
in that the second locking member has a locking portion and an actuating portion designed to be actuated by a user so as to displace the second locking member between:
an unlocked position in which the locking portion of the second locking member is liable to have passed through the lumen arranged in the door; and
a locked position in which the locking portion of the second locking member is liable to bear on the door so as to ensure that the body is fastened to the door;
in that the first locking member and the second locking member are connected by an elastically deformable connecting portion so as to form pliers.

10. The device according to claim 4, wherein the first locking member has a connecting portion connected to the body and liable to be elastically deformed for displacing the first locking member between the unlocked position and the locked position.

11. The device according to claim 10, wherein the fastening means comprise a second locking member extending substantially parallel to the first locking member.

12. The device according to claim 4, wherein the fastening means comprise a plate mounted on the body and provided with a lumen, this lumen having a section that is substantially identical to the section of a lumen arranged in the door; and
in that the first locking member is removeably mounted on the body and has an actuating portion designed to be actuated by a user so as to displace the first locking member between:
an unlocked position in which the locking portion of the first locking member is liable to be engaged through the lumen arranged in the plate and the lumen arranged in the door; and
a locked position in which the locking portion of the first locking member pivots around an axis, so as to bear on the door and fasten the body to the door.

13. The device according to claim 12, wherein the axis, is arranged to extend transversally to the lumen arranged in the door and to the lumen arranged in the plate.

14. The device according to claim 1, wherein the door is provided with at least one lumen;
in that the fastening means comprise a plate mounted on the body, provided with at least one protuberance of general “L” shape, this protuberance being arranged to be transversally engaged in a lumen of the door then translated substantially parallel to the lumen of the door, so as to bear on the door; and
in that the fastening means comprise a locking member mounted on the plate, the locking member having a locking portion, an actuating portion and a connecting portion connecting the locking portion and the actuating portion, the locking member being elastically deformable between:
an unlocked position in which the locking portion allows the engaging of said protuberance in said lumen of the door; and
a locked position in which the locking portion prevents the clearing of said protuberance in said lumen of the door.

15. The device according to claim 1, wherein the fastening means comprise a plate mounted on the body and provided with an orifice; and
in that the fastening means comprise a screw liable to be engaged through the orifice arranged in the plate and the orifice arranged in the door and bolted so as to ensure that the body is fastened to the door.

16. A kit comprising:
at least one device according to claim 1,
at least one protective member.

17. The kit according to claim 16, wherein the protective member comprises a profiled element including a base, a first lateral wall and a second lateral wall which together delimit a housing intended to receive a groove of a body element, said first lateral wall and/or said second lateral wall having a radial elasticity determined such that the first lateral wall and/or the second lateral wall are spaced apart from each other so as to put the groove of the body element in said housing then they become closer to each other so as to ensure holding the groove of the body element, in said housing of the profiled element.

18. The kit according to claim 17, wherein one of the lateral walls of the profiled element further comprises at least one protruding element oriented on the side of the housing of the profiled element.

19. A motor vehicle including at least one door and one body element, wherein it is equipped with a device according to claim 1.

20. The motor vehicle according to claim 19, wherein it further comprises at least one protective member.
